(19) United States
(12) Patent Application Publication
(10) Pub. No.: US 2010/0001131 A1
(43) Pub. Date: Jan. 7, 2010

(54) Method of and Apparatus for Producing Aerodynamic Resistance on an Aircraft

(75) Inventors: Anil B. Mertol, Bremen (DE); Volker Cleemann, Ohrensen (DE); Carsten Weber, Bremen (DE); Markus Fischer, Weyhe (DE)

Correspondence Address: Sunstein Kann Murphy & Timbers LLP, 125 SUMMER STREET, BOSTON, MA, 02110-1618, US

(73) Assignee: AIRBUS DEUTSCHLAND GMBH, Hamburg (DE)

(21) Appl. No.: 12/301,751

(22) PCT Filed: May 9, 2007
(86) PCT No.: PCT/EP2007/054483

§ 371 Date: May 4, 2009

(30) Foreign Application Priority Data
May 31, 2006 (DE) 10 2006 025 752.9

(51) Int. Cl. B64C 9/32; B64C 9/36

(52) U.S. Cl. 244/113

(57) ABSTRACT

The invention concerns an apparatus for and a method of producing aerodynamic resistance on an aircraft, comprising at least one braking flap, wherein the at least one braking flap can be extended into the airflow around the aircraft. In accordance with the invention at least one braking flap is arranged on the fuselage of the aircraft in a region over the wings of the aircraft.

The invention relates to an apparatus for and a method of producing aerodynamic resistance on an aircraft, with at least one braking flap, wherein the at least one braking flap can be extended into the airflow around the aircraft. The invention further relates to an aircraft equipped with at least one braking flap, wherein the at least one braking flap can be extended into the airflow around the aircraft.

In the landing approach of an aircraft its speed is reduced to the lowest possible value in order to restrict the required length of the landing runway. Furthermore, in order to reduce the flight noise on the ground, it is desirable to minimise as much as possible the noise-polluted area, by virtue of a steep landing approach. A high lift coefficient is required for that purpose in order to be able to provide for a slow approach. In order to achieve an approach flight path which is steep and slow, besides the high-lift systems required for that purpose, there is also a need for effective braking apparatuses. In the ideal situation those braking apparatuses increase exclusively the air resistance of the aircraft and do not influence either the lift or the pitching, rolling or yawing moment of the aircraft. In addition, in order further to limit the noise pollution, the braking apparatuses should cause as little additional source noise as possible.

For effectively reducing the flight speed of an aircraft in the landing approach use is usually made of braking flaps which are arranged substantially in the region of the trailing edge of an aircraft wing (hereinafter those braking flaps are also referred to as “spoilers”). By virtue of their position directly on the aircraft wing, extended spoilers decisively influence the flow around the wing and consequently reduce the lift-increasing action of the wing trailing edge flaps (landing flaps) and the wing leading edge flaps (slats). In most cases, with the spoilers extended, the longitudinal moment budget of the aircraft changes, whereby it is necessary to continuously compensate in particular for an altered pitching moment by means of the elevator unit. The flight noise is also markedly increased due to the reduced lift and the higher landing speed that this entails as the aircraft cell noise increases exponentially with the flight speed. In addition the source noise produced by the extended spoilers is amplified.

As an alternative arranged at the underside of the aircraft fuselage are braking flaps which can be extended into the airflow around the aircraft (“ventral airbrake”). Due to geometrical limitations (that is to say the width of the aircraft fuselage, the minimum distance of the aircraft fuselage from the ground and the installation situation of the undercarriage), the extended size and therewith also the action of a ventral airbrake are restricted. In many cases, it is not possible to produce sufficient air resistance with such braking flaps, so that the use thereof is limited. Furthermore, it is necessary to reckon on detrimental noise emission in the direction of the ground as the noise generated by the ventral airbrake is not screened either by the aircraft fuselage or the wings.

So-called “petal airbrakes” are usually arranged at the tail of the aircraft and can be pivotably extended sideways in the direction of flight on each side of the aircraft. A disadvantage with that kind of apparatus is the effect of the limited installation volume available in the fuselage tail region (that is to say limitation due to system installations such as the auxiliary power unit—APU—, tail unit mounting to the fuselage etc.). A further disadvantage is that this kind of apparatus is arranged in flow-mechanical regions of low kinetic energy. For those aforementioned reasons the implementation of resistance by the petal airbrakes is limited.

A further possible way of producing resistance is the so-called split rudder. A disadvantage with that kind of apparatus is the limited installation space available as well as the restricted capability for carrying structural air loads in the rudder assembly region. It is also found when using that apparatus that the yaw-stabilising action of the rudder assembly is markedly reduced. For the aforementioned reasons that kind of apparatus can afford only a low level of potential resistance implementation.

Therefore the object of the invention is to reduce or eliminate one or more of the above-discussed problems of known solutions. In particular the object of the invention is to provide an apparatus for producing aerodynamic resistance on an aircraft, which does not reduce the lift, which causes less noise and which does not exert an additional moment on the aircraft.

That object is attained by at least one braking flap which is arranged on the fuselage of the aircraft in a region over the wings of the aircraft.

Those braking flaps (dorsal airbrakes) are arranged within a region on the aircraft fuselage, in which a high dynamic pressure in respect of the airflow obtains. In the case of conventional commercial aircraft a suitable area of high dynamic pressure for mounting these apparatuses is to be found for example over the low-pressure side of the aircraft wings, near the fuselage, being the side on which the airflow is accelerated. Arranging the braking flaps on the fuselage in that region reduces the dynamic pressure of the airflow. The energy applied for that purpose is taken from the kinetic energy of the aircraft.

Altering the distribution of pressure specifically at the wing in a high-lift configuration by means of that kind of apparatus causes a down-pitching moment (negative pitching moment contribution). The afflux flow in relation to the braking flaps additionally causes an up-pitching moment (positive pitching moment contribution). Those two pitching moment contributions balance out by virtue of a suitably selected exact positioning of the braking flaps on the aircraft. In addition the induced resistance of the aircraft can also be increased by ideal positioning of the braking flaps on the aircraft, which in combination with the above-described increase in pressure resistance leads to a further increase in braking action. The braking action of the dorsal airbrakes influences the flow around the wings and thus the high-lift flaps markedly less than a conventional spoiler arrangement. The change in pressure distribution can accordingly both increase the resistance and also reduce the loss of lift.

The noise production of such braking flaps is also substantially less in comparison with known solutions as the wings and the aircraft fuselage screen towards the ground the noise resulting from the braking flaps. Replacement of the spoilers mounted on the wings and advantageously influencing the flow around the wing leading edge flaps (slats) means that it is possible to reduce the overall noise of the aircraft by the dorsal airbrakes.

Preferably two, three, four or more braking flaps which are spaced from each other in the peripheral direction are arranged on the fuselage of the aircraft in a region over the wings of the aircraft. Due to the spherical curvature of the aircraft fuselage it is geometrically advantageous to use a plurality of smaller braking flaps which are arranged in a row over a cross-sectional section in the region of the top side of the aircraft fuselage. Furthermore, when using in particular two braking flaps or two pairs of braking flaps, it is possible for the eddy turbulence wake thereof to be so directed, by virtue of a suitable spacing between the braking flaps, that disruption of the rudder assembly which is arranged towards the tail, by virtue of air eddies, can be reduced or avoided.

It is preferable if the braking flaps are arranged symmetrically relative to each other in the peripheral direction relative to the central plane of the fuselage. That eliminates additional pitching, rolling or yawing moments which could arise due to asymmetrical braking forces.

In an advantageous embodiment the ends of the braking flaps, which face away from the fuselage of the aircraft, have a straight edge. Manufacture or machining of the braking flaps and in particular the connecting portions which seal off flush in the aircraft fuselage for retracted braking flaps can be effected relatively inexpensively as a result.

In a further preferred feature moreover serrated, profiled, perforated or rounded-off edges are provided at the ends of the braking flaps, which face away from the aircraft fuselage. By virtue thereof, with a suitable design, it is possible both to improve the dynamic action and also reduce the generation of noise.

It is particularly favourable if the at least one braking flap is of a substantially rectangular shape. Manufacture of the braking flap and the sealing regions in the aircraft fuselage is simplified thereby and the braking characteristics of rectangular flaps are known.

Finally it is particularly preferred if the at least one braking flap can assume any suitable shape. A suitable shape can be afforded for example by experiment or simulation.

In a particularly preferred embodiment the two, three or more braking flaps are drivable independently of each other. That permits integration of the braking flaps into the flight attitude regulation of the aircraft in the landing approach or in other phases and can be used to optimise the moment budget of the aircraft.

The object of the invention is further attained by a method of producing aerodynamic resistance on an aircraft, in which at least one braking flap arranged on the fuselage of the aircraft in a region over the wings of the aircraft is extended into the airflow around the aircraft.

Finally the object of the invention is attained by an aircraft with at least one braking flap, wherein the at least one braking flap can be extended into the airflow around the aircraft and wherein the at least one braking flap is arranged on the fuselage of the aircraft in a region over the wings of the aircraft.

A particularly preferred embodiment is designed in accordance with the above-described features of the apparatus for producing resistance on an aircraft.

The invention will be described in greater detail hereinafter by means of an embodiment by way of example with reference to the Figures. The same references are used in the specific description hereinafter for the same or similar elements. In the drawing:

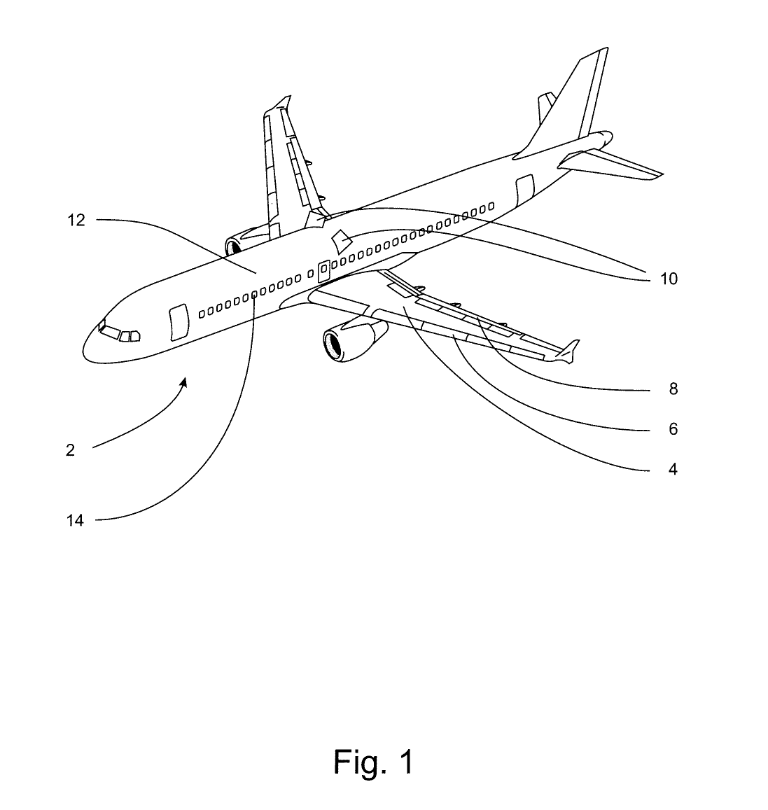

FIG. 1 shows a perspective view of an aircraft with braking flaps according to the present invention, and

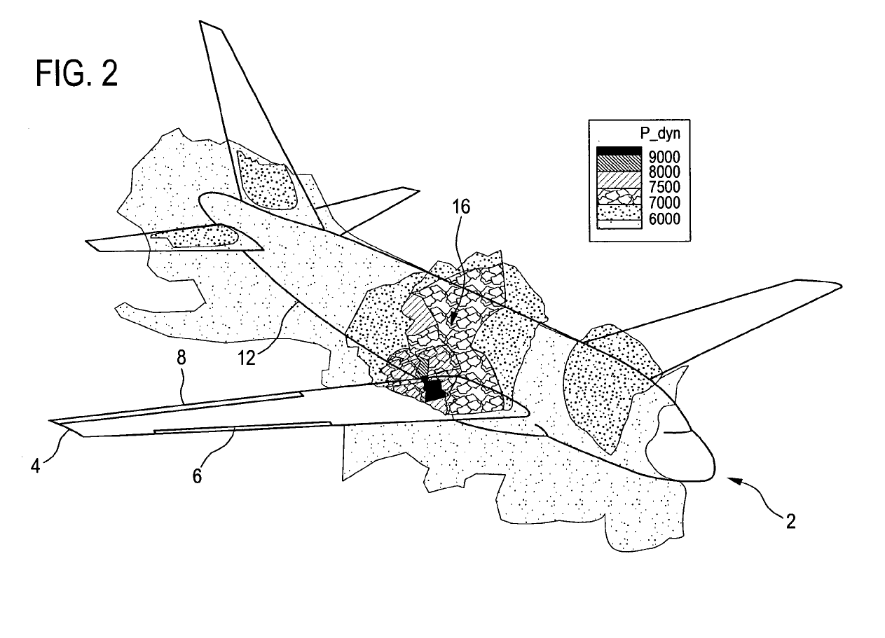

FIG. 2 shows the dynamic pressure distribution on an aircraft fuselage.

FIG. 1 shows an aircraft 2 with two wings 4 which are equipped with wing leading edge flaps 6 (slats) and wing trailing edge flaps 8 (flaps). In the landing approach both the flaps 8 and also the slats 6 are extended and provide a lift coefficient which is greatly increased in comparison with cruising flight and which permits a major reduction in the flight speed during the landing approach.

In the landing approach, in addition to the reduction in thrust and to the increased overall air resistance of the aircraft due to extended slats 6 and flaps 8, it is necessary to further reduce the speed of the aircraft 2 by means of braking flaps or to keep it constant in consideration of the permanent descending flight. That is effected in the present case by two braking flaps 10 which are disposed in a region of the aircraft fuselage 12 which is over a plane defined by the wings 4.

The braking flaps 10 are of such a configuration that, in their position of maximum extension, they are approximately perpendicularly to the surface of the aircraft fuselage 12. The area and the outward extension of the braking flaps 10 is limited by the required braking efficiency or the required air resistance, the available space on the aircraft fuselage and the curvature thereof, and the necessary actuator power. An instantaneous braking action can be influenced by varying the angle of pivotably extended braking flaps 10.

The geometrical configuration of the edges of the braking flaps 10 depends in particular on the requirements in regard to the noise which occurs. The general geometry of the braking flaps 10 can be rectangular or can assume any suitable shape.

It is possible, in place of a pair of braking flaps consisting of two braking flaps 10, also to use only one or even more braking flaps 10 which for example can be arranged above the windows 14 over the wings.

A plurality of braking flaps 10 could additionally contribute to stabilising the moment budget of the aircraft insofar as they are preferably drivable separately from each other and are integrated into the flight attitude regulation during the landing approach or other phases.

The position of the new braking flaps 10 on the top side of the fuselage is defined inter alia by the distribution of the dynamic pressure at the fuselage, as is shown in FIG. 2.

It is clearly apparent in FIG. 2 that a local maximum in respect of dynamic air pressure is to be found in a region 16 of the aircraft 2. The braking flaps 10 should preferably be arranged in that region 16 and should be of such a configuration that they make the most effective possible use of that dynamic pressure and provide an optimum braking action. The preferred location in that region 16 is accordingly a location 18 at which the local dynamic pressure is at a maximum. There the so-called over-speed, that is to say an airflow speed which exceeds the afflux flow speed of the aircraft, reaches its local maximum.

Arranging the braking flaps 10 in the region 16 at the top side of the aircraft fuselage 12 causes a reduction in noise on the ground as the braking flaps 10 are disposed over the wings 4 and the aircraft fuselage 12 which screen the noise produced, towards the ground. If in an aircraft configuration the spoilers mounted on the wings 4 are dispensed with, the noise caused by the flaps 8 and the slats 6 can also be reduced by an improvement in the flow conditions at the wings 4.

The present invention provides braking flaps which provide a braking action similar in comparison with conventional spoilers mounted to the wings 4, but in that case they do not disrupt the moment budget of the aircraft and they generate substantially less noise in the landing approach. The embodiment used serves only for the purposes of description of the present invention and is not intended to restrict it to that embodiment. It is further possible to use any kind of braking flaps on the aircraft 2 over the wings 4 which reduce the dynamic pressure there and thus bring about a braking action. With suitable tailplane assemblies it would additionally also be conceivable for such braking flaps to be arranged additionally or exclusively in the region of the fuselage tail. In particular the invention relates to a passenger aircraft.

What is claimed is:

1-11. (canceled)

12. An aircraft comprising at least one braking flap, wherein the at least one braking flap can be extended into the airflow around the aircraft, characterised in that the at least one braking flap is arranged on the fuselage of the aircraft in a region over the wings of the aircraft, in which a local maximum in respect of dynamic air pressure is present, wherein the at least one braking flap is arranged for balancing out a down-pitching moment and an up-pitching moment.

13. The aircraft according to claim 12 characterised in that two, three, four or more braking flaps spaced from each other in the peripheral direction are arranged on the fuselage of the aircraft in a region over the wings of the aircraft.

14. The aircraft according to claim 13 characterised in that the braking flaps are arranged in mutually symmetrical relationship in the peripheral direction relative to the central plane of the fuselage.

15. The aircraft according to claim 13 characterised in that the ends of the braking flaps, which face away from the fuselage of the aircraft, have a straight edge.

16. The aircraft according to claim 13 characterised in that the ends of the braking flaps, which face away from the fuselage of the aircraft, have a serrated, profiled, perforated or rounded-off edge.

17. The aircraft according to claim 12 characterised in that the at least one braking flap is of a substantially rectangular shape.

18. The aircraft according to claim 13 characterised in that the braking flaps are drivable independently of each other.

19. A method of producing aerodynamic resistance on an aircraft, characterised in that at least one braking flap arranged on the fuselage of the aircraft in a region, in which a local maximum in respect of dynamic air pressure is present, over the wings of the aircraft is extended into the airflow around the aircraft, wherein the at least one braking flap is arranged for balancing out a down-pitching moment and an up-pitching moment.
